(19) United States
(12) Patent Application Publication
(10) Pub. No.: US 2025/0187393 A1
(43) Pub. Date: Jun. 12, 2025

(54) Housing for an HVAC unit

(71) Applicant: VALEO SYSTEMES THERMIQUES, La Verriere (FR)

(72) Inventors: Jason KREUCHER, Auburn Hills, MI (US); Richard SIKORSKI, Auburn Hills, MI (US)

(73) Assignee: VALEO SYSTEMES THERMIQUES, La Verriere (FR)

(21) Appl. No.: 18/530,801

(22) Filed: Dec. 6, 2023

(51) Int. Cl. B60H 1/00

(52) U.S. Cl. CPC B60H 1/00514

(57) ABSTRACT

A housing for an HVAC unit, including: a first housing part with a first fixation component, a second housing part with a second fixation component, a divider wall arranged between the first housing part and the second housing part, configured to at least partly divide the housing into a first side and a second side, so that the first housing part, the divider wall and the second housing part are stacked in a stacking direction. The first housing part is fixed directly to the second housing part. The divider wall includes an aligning component configured to align the first fixation component so that the first housing part is aligned with the divider wall before the first fixation component is connected with the second fixation component.

### TECHNICAL FIELD

The present disclosure relates to a Heating Ventilation and Air Conditioning (HVAC) unit for a vehicle.

### BACKGROUND OF THE INVENTION

Vehicles are known to incorporate HVAC units to improve the comfort of the people within the passenger compartment of the vehicle. The HVAC units heat and cool air blown through the HVAC unit using a heating heat exchanger and/or a cooling heat exchanger. A blower device is commonly used to ensure movement of the air within the HVAC unit. The heating heat exchanger typically utilizes the engine coolant as a source of heat for heating the air. The cooling heat exchanger is typically an evaporator, which is part of an air conditioning unit in the vehicle powered by the engine of the vehicle. The air blown through the HVAC unit comes from air outside the vehicle, air inside the passenger compartment of the vehicle or a combination of the air outside the vehicle and the air inside the passenger compartment of the vehicle. The air being blown through the HVAC unit is conditioned (heated/cooled) and is then directed into the passenger compartment of the vehicle through one or more outlet vents.

HVAC units include housing containing at least a portion of the above-mentioned components. As the housing may include a plurality of sub-parts that have to be assembled together, there is a need to provide a connection solution to fix the sub-parts together.

### SUMMARY OF THE INVENTION

An object of the invention is a housing for an HVAC unit, comprising: a first housing part with a first fixation component, a second housing part with a second fixation component, a divider wall arranged between the first housing part and the second housing part, configured to at least partly divide the housing into a first side and a second side, so that the first housing part, the divider wall and the second housing part are stacked in a stacking direction, wherein the first housing part is fixed directly to the second housing part, wherein the divider wall includes an aligning component configured to align the first fixation component so that the first housing part is aligned with the divider wall before the first fixation component is connected with the second fixation component.

In one example, the first fixation component, the aligning element and the second fixation component are arranged to cooperate along a fixation axis extending parallel to the stacking direction.

In one example, the first fixation component includes a locator pin, while the second fixation component includes a collar configured to accept the locator pin.

In one example, the aligning element is arranged closer to the first housing portion than to the second housing portion in the stacking direction.

In one example, the collar extends towards the first housing part over at least a portion of the divider wall in the stacking direction.

In one example, the collar extends towards the first housing part over at least majority of the divider wall in the stacking direction.

In one example, the locator pin and the collar are configured to be connected by a screw.

In one example, the locator pin and the collar are configured to be connected by a screw so that the screw extends along a fixation axis extending parallel to the stacking direction.

In one example, the aligning component includes a locator hole configured to accept the locator pin so that the locator pin is guided to the collar through the locator hole.

In one example, the second fixation component includes gussets supporting the collar.

In one example, the second fixation component includes gussets supporting the collar, wherein the fixation axis, defines a central axis of the collar, the collar including a collar bottom with a second opening configured to accept the screw, with the collar bottom including a supported portion supported by the gussets and a cleared portion unsupported by the gussets.

In one example, the gussets include side gusset arms and a middle gusset arm arranged between the side gussets arms so that the side gusset arms and the middle gusset arm terminate at a circumference of the collar bottom while leaving it accessible when viewed along the fixation axis.

### BRIEF DESCRIPTION OF DRAWINGS

The present invention will be described in greater detail below with reference to the drawings. In the drawings:

FIG. 1 shows an HVAC unit in a perspective view;

FIG. 2 shows a housing for the HVAC unit in a closer view;

FIG. 3 shows isolated fixation components of the housing in a perspective view; and

FIG. 4 shows fixation components of the housing in an exploded view.

### DETAILED DESCRIPTION OF THE INVENTION

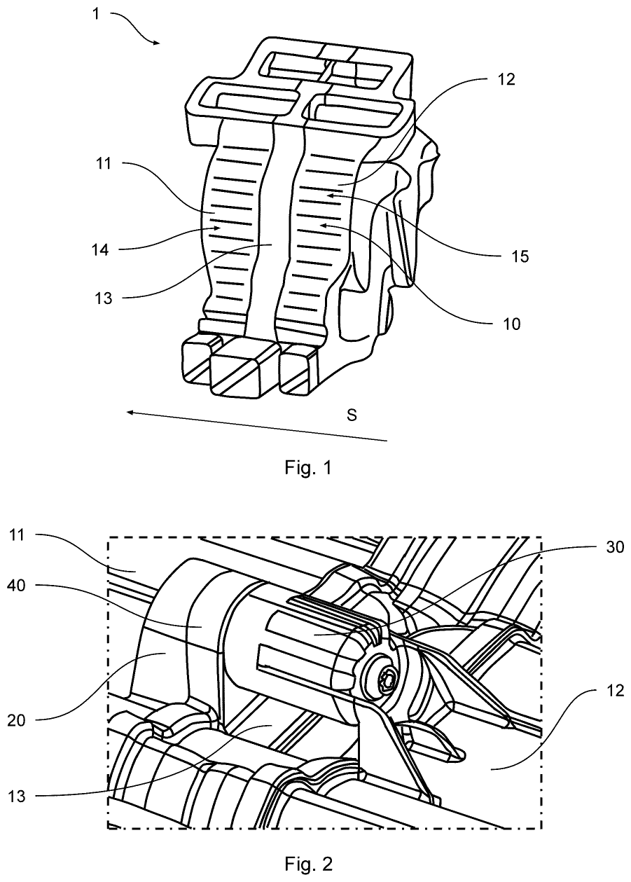

FIG. 1 shows an HVAC unit 1 in a perspective view, with FIG. 2 showing a housing 10 for the HVAC unit 1 in a closer view to highlight the fixation components.

The housing 10 includes a first housing part 11 with a first fixation component 20 and a second housing part 12 with a second fixation component 30. The first fixation component 20 is intended to be connected to the second fixation component 30 so that the first housing part 11 is connected to the second housing part 12. In this example, the first housing part 11 is fixed directly to the second housing part 12.

The housing 10 further includes a divider wall 13 arranged between the first housing part 11 and the second housing part 12. The divider wall 13 is configured to at least partly divide the housing 10 into a first side 14 and a second side 15. The first housing part 11, the divider wall 13 and the second housing 12 part are then stacked in a stacking direction S.

The divider wall 13 includes an aligning component 40 configured to align the first fixation component 20 so that the first housing part 11 is aligned with the divider wall 13 before the first fixation component 20 is connected with the second fixation component 30.

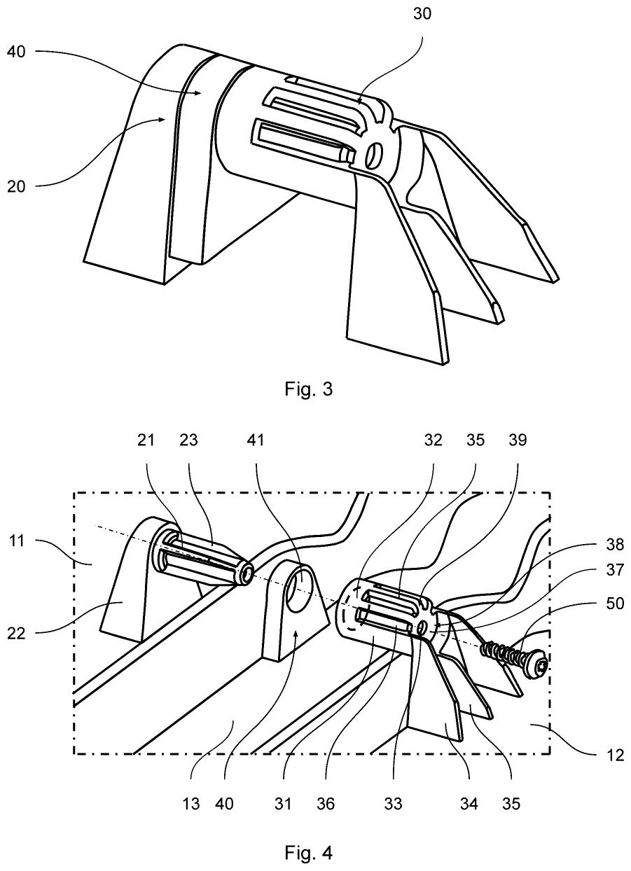

FIG. 3 shows isolated fixation components of the housing in a perspective view and FIG. 4 shows fixation components 20, 30 of the housing 10, together with the aligning component 40, in an exploded view. In FIG. 4, the first housing part 11, the second housing part 12 and the divider wall 13 are simplified compared to FIG. 2 for the sake of clarity.

The first fixation component 20, the aligning element 40 and the second fixation component 30 can be arranged to cooperate along a fixation axis Xf extending parallel to the stacking direction S.

The first fixation component 20 can include a locator pin 21, while the second fixation component 30 can include a collar 31 configured to accept the locator pin 21. The central axes of the locator pin 21 and the locator pin can be collinear with the fixation axis Xf.

The aligning element 40 can be arranged closer to the first housing portion 11 than to the second housing portion 12 in the stacking direction S. In other words, the aligning element 40 can be arranged closer to the edge of the divider wall 13 facing the first housing portion 11 than to the opposite edge of the divider wall 13, which faces the second housing portion 12.

The collar 31 can extend towards the first housing part 11 over at least a portion of the divider wall 13.

The locator pin 21 and the collar 31 can be configured to be connected by a screw 50. The screw 50 extends along a fixation axis Xf extending parallel to the stacking direction S. The locator pin 21 can have a threaded opening for accepting the screw 50.

As shown in the figures, the screw 50 can extend over at least part of the divider wall 13, and preferably over the majority of the divider wall 13 in the stacking direction S.

The aligning component 40 can include a locator hole 41 configured to accept the locator pin 21 so that the locator pin 21 is guided to the collar 31 through the locator hole 41. The central axis of the locator hole 41 is then collinear with the fixation axis Xf.

The second fixation component can include gussets 34a, 34b supporting the collar 31.

In one example, the fixation axis Xf, can define (i.e. be collinear with) the central axis of the collar 31. The collar 31 can include a collar bottom 37 with a second opening 33 configured to accept the screw 50, with the collar bottom 37 including a supported portion 38 supported by the gussets 34a, 34b and a cleared portion 39 unsupported by the gussets 34a, 34b.

In one example, the gussets 34, 35 include side gusset arms 34 and a middle gusset arm 35 arranged between the side gussets arms 35 so that the side gusset arms 34 and the middle gusset arm 35 terminate at a circumference of the collar bottom 37 while leaving it accessible when viewed along the fixation axis Xf. The side gusset arms 34 and the middle gusset arm 35 can extend from the second housing part 12 as walls. The side gusset arms 34 can extend from the second housing part 12 for a distance longer than the distance for which the middle gusset arm 35 extends from the second housing part 12. The gusset arms 34, 35 can be connected to each other by connecting walls to improve rigidity. The gusset arms 34, 35 can be in form of flat triangles. The gusset arms 34, 35 can be in form of flat triangles with cut top corners, which can aid introduction of the screw or of machine used to fix the screw.

The collar 31 can include collar ribs 35 extending along the fixation axis Xf. The collar ribs 35 can be separated from each other by collar slots 36 also extending along the fixation axis Xf.

Thanks to the proposed solution, after fixing the components are tightly connected to each other so that the relative movement of the housing components is prevented.

A need for a plurality of screws and fixation components is alleviated, as a single screw 50 is able to fix three parts of the housing at the same time. This is the case especially when the divider wall 13 is relatively wide. This leads to reduction in assembly process time, and allows all bosses to be driven in one direction that secures three parts. The whole unit does not have to be rotated by the assembly operator to fix a plurality of screws from another side or direction. The aligned components create a relationship for other features as door bearings across all parts, resulting in better quality of the HVAC unit.

Other variations to the disclosed embodiments can be understood and effected by those skilled in the art in practicing the claimed invention, from a study of drawings, the disclosure, and the appended claims. The mere fact that certain measures are recited in mutually different dependent claims does not indicate that a combination of these measures cannot be used to the advantage.

1. A housing for an HVAC unit, comprising:
a first housing part with a first fixation component,
a second housing part with a second fixation component,
a divider wall arranged between the first housing part and the second housing part, configured to at least partly divide the housing into a first side and a second side, so that the first housing part, the divider wall and the second housing part are stacked in a stacking direction,
wherein the first housing part is fixed directly to the second housing part,
wherein the divider wall includes an aligning component configured to align the first fixation component so that the first housing part is aligned with the divider wall before the first fixation component is connected with the second fixation component.

2. The housing according to claim 1, wherein the first fixation component, the aligning element and the second fixation component are arranged to cooperate along a fixation axis extending parallel to the stacking direction.

3. The housing according to claim 1, wherein the first fixation component includes a locator pin, while the second fixation component includes a collar configured to accept the locator pin.

4. The housing according to claim 2, wherein the aligning element is arranged closer to the first housing portion than to the second housing portion in the stacking direction.

5. The housing according to claim 3, wherein the collar extends towards the first housing part over at least a portion of the divider wall in the stacking direction.

6. The housing according to claim 3, wherein the collar extends towards the first housing part over at least majority of the divider wall in the stacking direction.

7. The housing according to claim 3, wherein the locator pin and the collar are configured to be connected by a screw.

8. The housing according to claim 3, wherein the locator pin and the collar are configured to be connected by a screw so that the screw extends along a fixation axis extending parallel to the stacking direction.

9. The housing according to claim 3, wherein the aligning component includes a locator hole configured to accept the locator pin so that the locator pin is guided to the collar through the locator hole.

10. The housing according to claim 3, wherein the second fixation component includes gussets supporting the collar.

11. The housing according to claim 8, wherein the second fixation component includes gussets supporting the collar, wherein the fixation axis, defines a central axis of the collar, the collar including a collar bottom with a second opening configured to accept the screw, with the collar bottom including a supported portion supported by the gussets and a cleared portion unsupported by the gussets.

12. The housing according to claim 11, wherein the gussets include side gusset arms and a middle gusset arm arranged between the side gussets arms so that the side gusset arms and the middle gusset arm terminate at a circumference of the collar bottom while leaving it accessible when viewed along the fixation axis.
